(19) United States
(12) Patent Application Publication
(10) Pub. No.: US 2026/0080808 A1
(43) Pub. Date: Mar. 19, 2026

(54) A ROAD INFORMATION DISPLAY SIGN APPARATUS

(71) Applicant: LAGAN CRAWL LIMITED, Galway (IE)

(72) Inventors: John MOYNIHAN, Galway (IE); Tony MAGUIRE, Galway (IE); Sean LOUGHLIN, Galway (IE); Scott BENNETT, Galway (IE); John COLEMAN, Galway (IE); Martin CLOWRY, Galway (IE); Neil MURRAY, Galway (IE); Dominic SOUTHGATE, Galway (IE)

(73) Assignee: LAGAN CRAWL LIMITED, Galway (IE)

(21) Appl. No.: 19/119,237

(22) PCT Filed: Oct. 27, 2023
(86) PCT No.: PCT/EP2023/080090

§ 371 Date: Apr. 8, 2025

(30) Foreign Application Priority Data
Oct. 28, 2022 (EP) 22204471.1

(51) Int. Cl. G09F 7/22; E01F 9/40; E01F 9/65; E01F 9/669; G09F 7/00; G09F 7/18

(52) U.S. Cl. CPC G09F 7/22; E01F 9/40; E01F 9/65; E01F 9/669; G09F 2007/005; G09F 2007/1856; G09F 2007/1878

(57) ABSTRACT

A display sign is for a central reservation barrier in some examples. It has a base to engage a barrier in a manner which envelopes the top surface and downwardly on the opposed side walls. A display with display elements provides information for drivers, and a display drive apparatus is mounted to the base and rotates the display about a vertical axis extending from the base. The drives can have a very low profile, with components being offset with respect to the display longitudinal axis. The drive provides that the display is aligned with a barrier in use when not required but is turned to an optimal angle for visibility by drivers according to the driving conditions. The drive brings the display back to the default in operative position when there is a power outage.

### INTRODUCTION

The present invention relates to roadside displays,

It is known to provide a display for a roadside, and an example is described in our prior published specification WO2022/136010 (LAGAN CRAWL LIMITED).

The present invention is directed towards providing a display with a support structure which is particularly robust and versatile.

### SUMMARY OF THE INVENTION

Claims 1 to 27 set out features of a display sign of the invention.

We describe a roadside display sign comprising:
a base configured to engage a barrier, wall or fence,
a display with display elements for providing information for drivers, and
a display drive apparatus mounted to the base and being adapted to rotate the display.

Preferably, the drive apparatus is adapted to rotate the display about a vertical axis extending from the base. Preferably, the base comprises a pair of opposed legs joined by a bridge to form a saddle shape to encompass the top of a wall or barrier, and the drive apparatus is mounted to the bridge. Preferably, the drive apparatus is mounted substantially centrally on the bridge, in a manner which is symmetrical with respect to the legs. Preferably, the drive apparatus comprises an output shaft which is linked to a shaft of the display.

Preferably, the drive apparatus has an output shaft which is joined by flanges to the display shaft. Preferably, the drive apparatus comprises a default mechanism to rotate the display to a default home orientation in absence of electrical or other power provided to the drive apparatus. Preferably, the default mechanism comprises a spring providing a bias to the home position.

Preferably, the spring is a helical spring. Preferably, the default mechanism comprises a rack engaging a gear on or linked to the display shaft, the rack being biased to slide to cause rotation of the gear to the home position. Preferably, the default mechanism comprises a biased rod which is actuated in a linear path to cause rotation of the display shaft to a home position.

Preferably, the rod is linked to a rack to move longitudinally to rotate a gear or to rotate a crank arm to cause rotation of the display shaft. Preferably, the drive apparatus comprises a motor.

Preferably, the motor is mounted alongside and offset from a longitudinal axis of the display shaft a lateral power transfer means is provided to link a motor output to the display shaft. Preferably, the base comprises a substrate having a saddle shape with a top plate and lateral legs extending downwardly and laterally on each lateral side and the substrate being arranged to be fastened at the top plate and the legs to a barrier. Preferably, the substrate is integral, and is preferably of metal material.

Preferably, the base comprises, on one or both legs, a removable cover for mounting over an array of light sources. Preferably, the substrate top plate supports a circuit and extends longitudinally in opposed directions beyond a central location supporting the circuit.

In some examples, the base comprises a pair of opposed legs joined by a bridge to form a saddle shape to encompass the top of a wall or barrier, and the default home position is parallel to the legs whereby the display does not protrude to a greater lateral extend than the base.

In some examples, the sign comprises a controller and sensors to detect angle of rotation of the display and to control rotation accordingly. The sensors may be rotary encoders of any known type to detect rotation of the drive shaft or a coupler secured to it. The sensors may additionally or alternatively be embedded within the motor.

In some examples, the sign comprises a battery storage device and a controller configured to monitor available power independently available to the sign and to pre-emptively cause the sign to rotate to the home default position in advance of power reducing excessively.

In some examples, the sign further comprises at least one tethering cable linked to the base and the display, the cable having a strength to retain the display in the event of an impact on the display.

In some examples, the cable is looped, being trained through the shaft and around a frame of the display and back to the base.

In some examples, the display comprises a frame with a vertical member aligned with the shaft and a cross member, and the tether is trained through said vertical and cross members.

In some examples, the vertical member is a continuation of the drive shaft and said drive shaft has rectangular cross-sectional shape.

In some examples, the drive apparatus is adapted to rotate the display to an angle of orientation chosen in real time according to conditions as indicated in data received from an interface.

In some examples, the conditions include current weather and/or current traffic.

### DETAILED DESCRIPTION OF THE INVENTION

The invention will be more clearly understood from the following description of some embodiments thereof, given by way of example only with reference to the accompanying drawings in which:

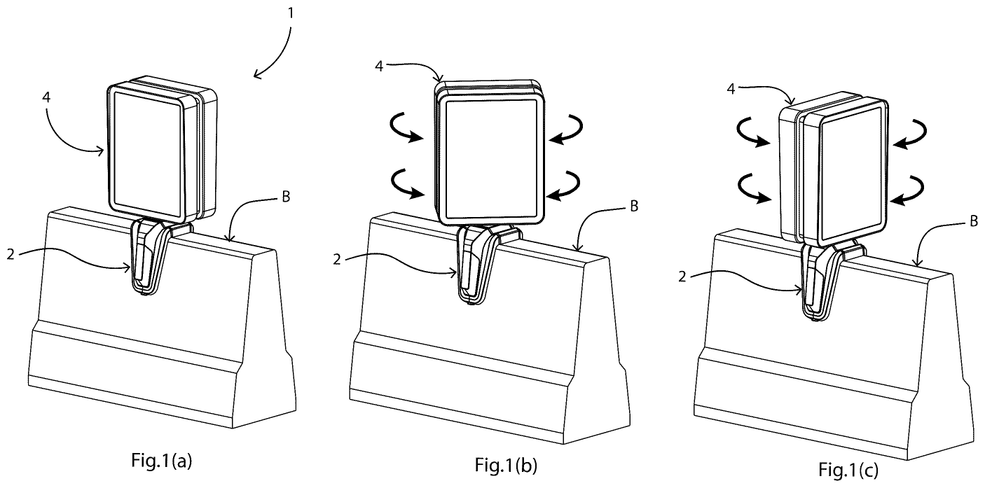

FIGS. 1(a), 1(b), and 1(c) are perspective views of a display sign of the invention in use when mounted on a roadside barrier,

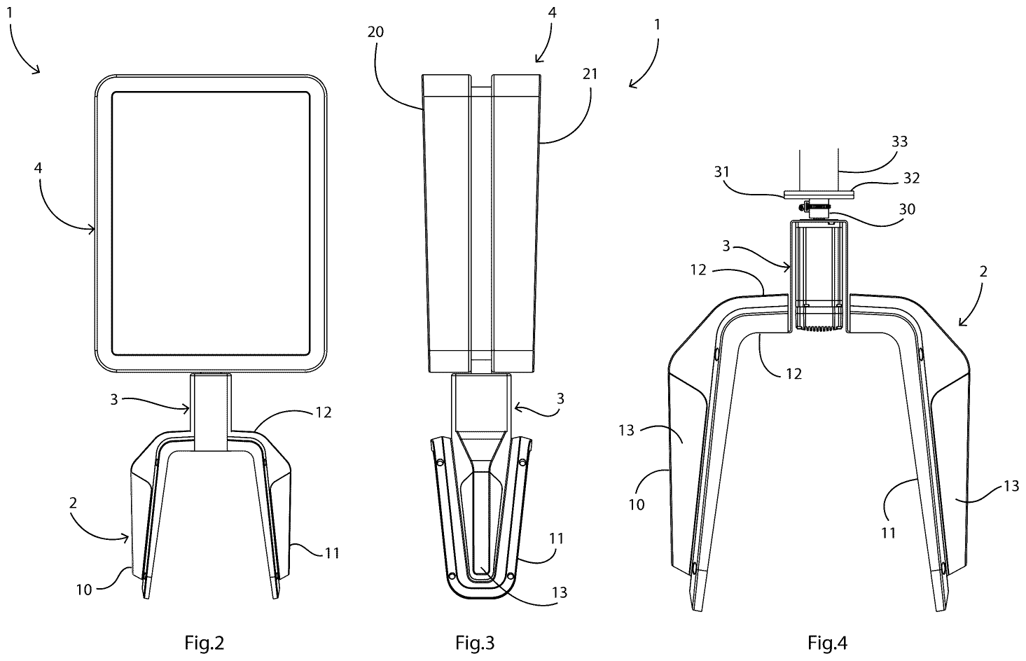

FIG. 2 is a front view of the display sign,

FIG. 3 is a side view, and

FIG. 4 is an enlarged front view showing the sign's support structure in more detail,

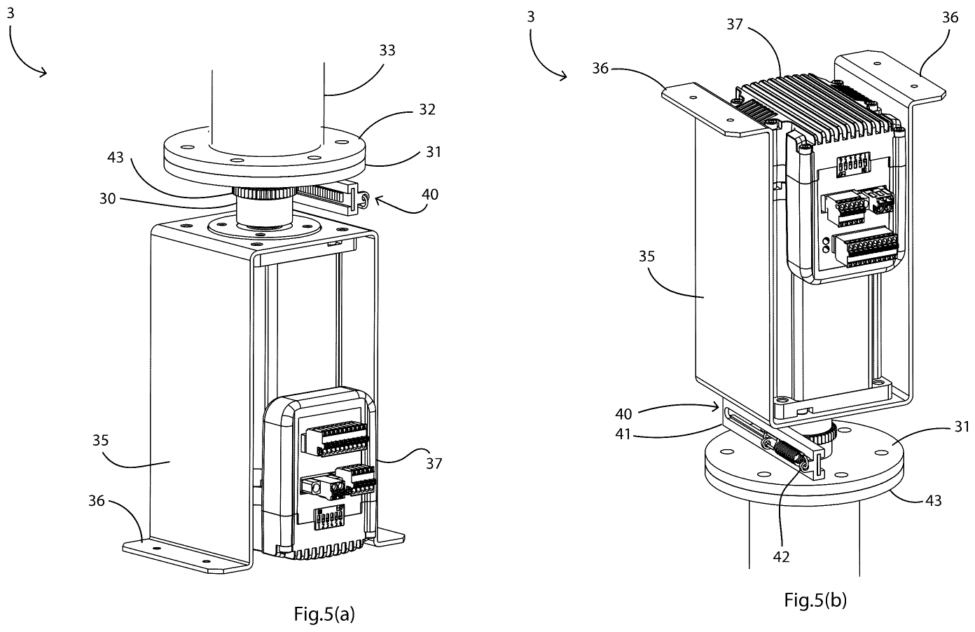

FIG. 5(a) is a top perspective view of the drive of the sign, and FIG. 5(b) is an underneath perspective view of the drive,

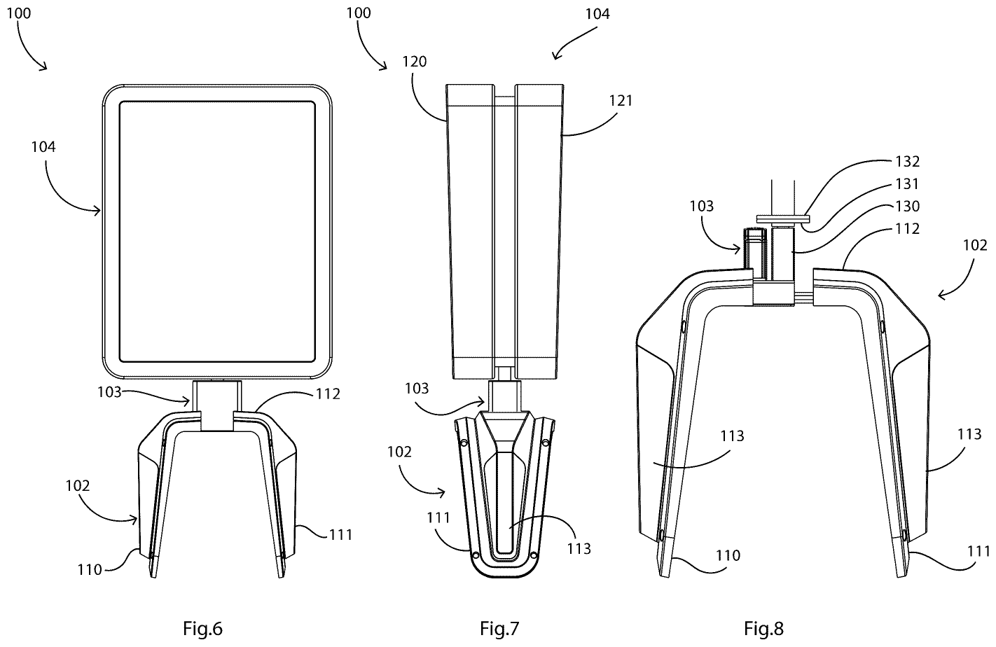

FIG. 6 is a front view of an alternative display sign of the invention,

FIG. 7 is a side view, and

FIG. 8 is an enlarged front view showing the sign's support structure in more detail,

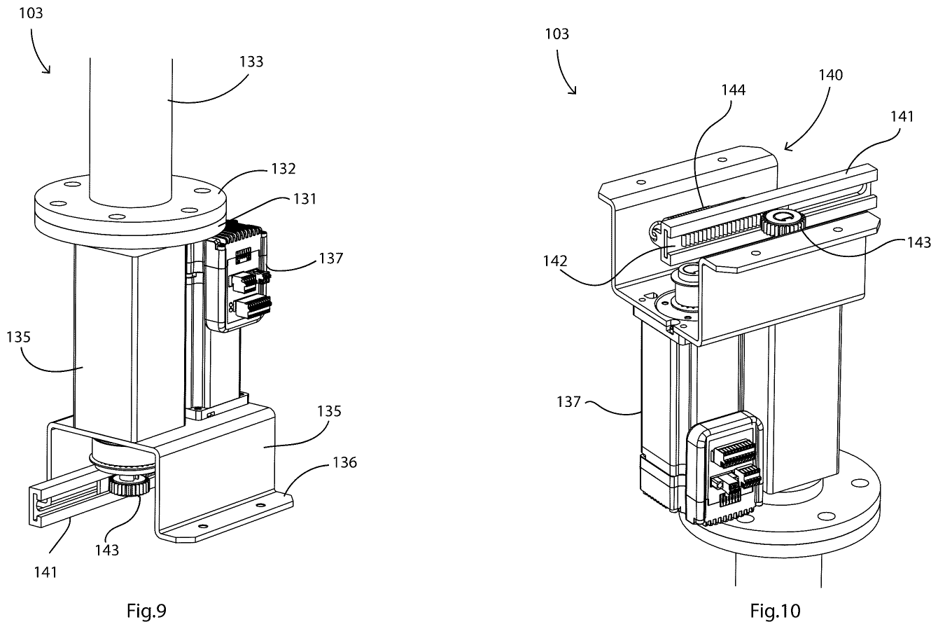

FIG. 9 is a top perspective view of the drive of the sign of FIGS. 6 to 8,

FIG. 10 is an underneath perspective view of the drive,

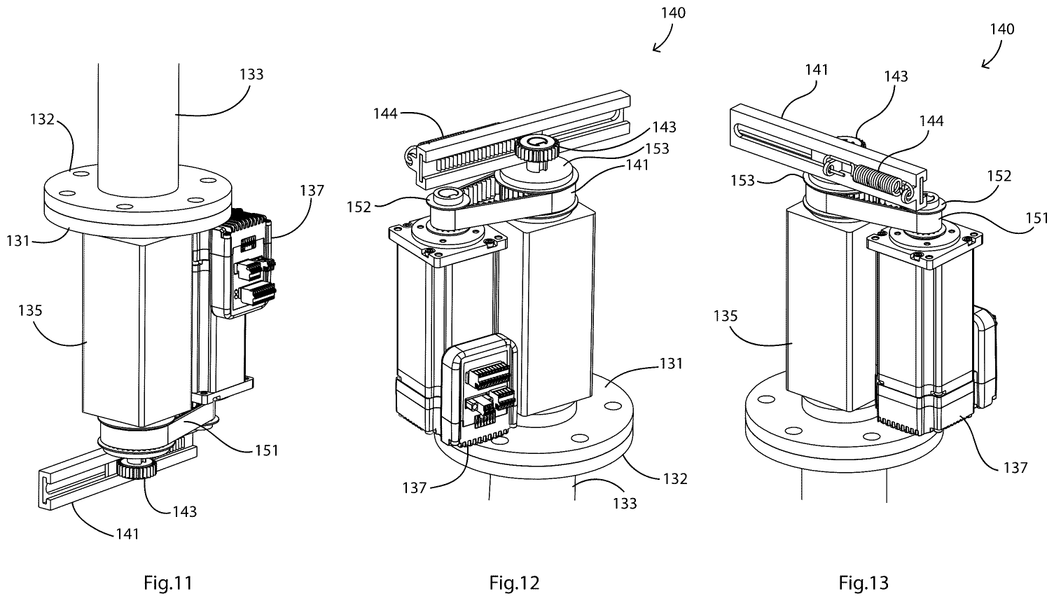

FIG. 11 is a top perspective view of the drive with the housing removed, and

FIGS. 12 and 13 are underneath perspective views from different angles again with the housing removed so that internal components are more clearly shown,

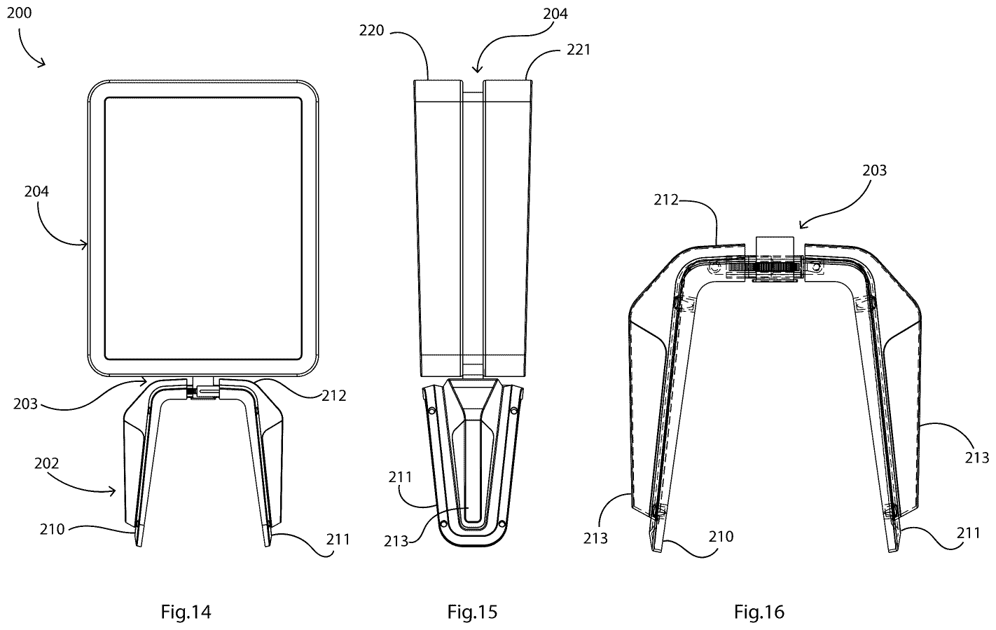

FIG. 14 is a front view of an alternative display sign of the invention,

FIG. 15 is a side view, and

FIG. 16 is an enlarged front view showing the sign's support structure in more detail,

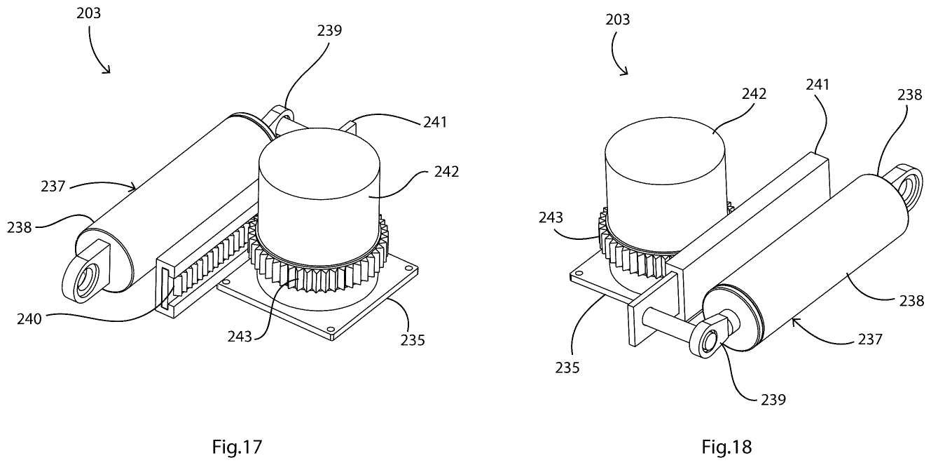

FIGS. 17 and 18 are top perspective view of the drive of the sign from different angles,

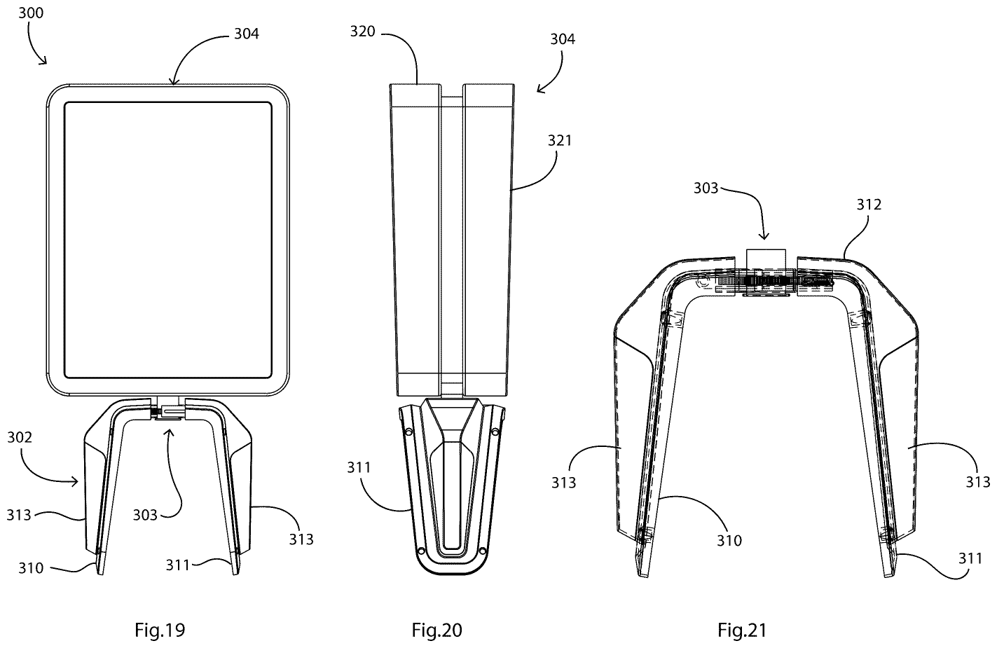

FIG. 19 is a front view of an alternative display sign of the invention,

FIG. 20 is a side view, and

FIG. 21 is an enlarged front view showing the sign's support structure in more detail,

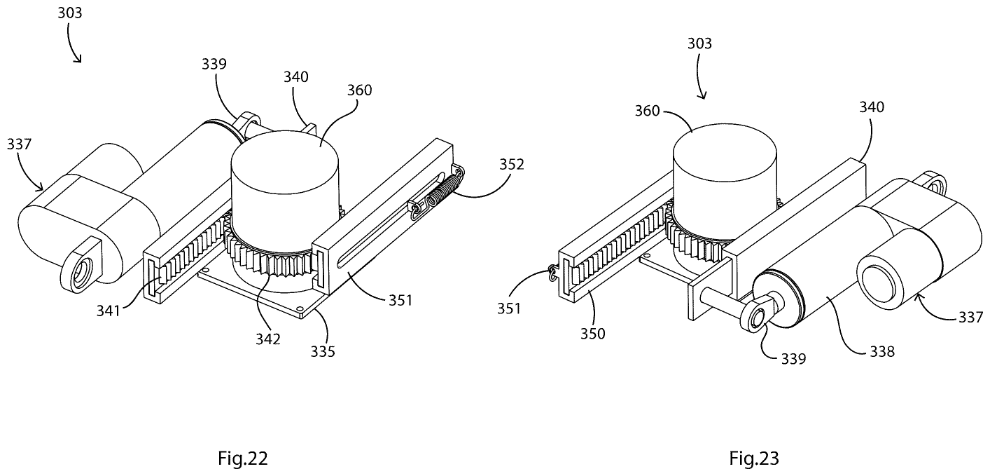

FIGS. 22 and 23 are top perspective view of the drive of the sign of FIGS. 19 to 21 from different angles,

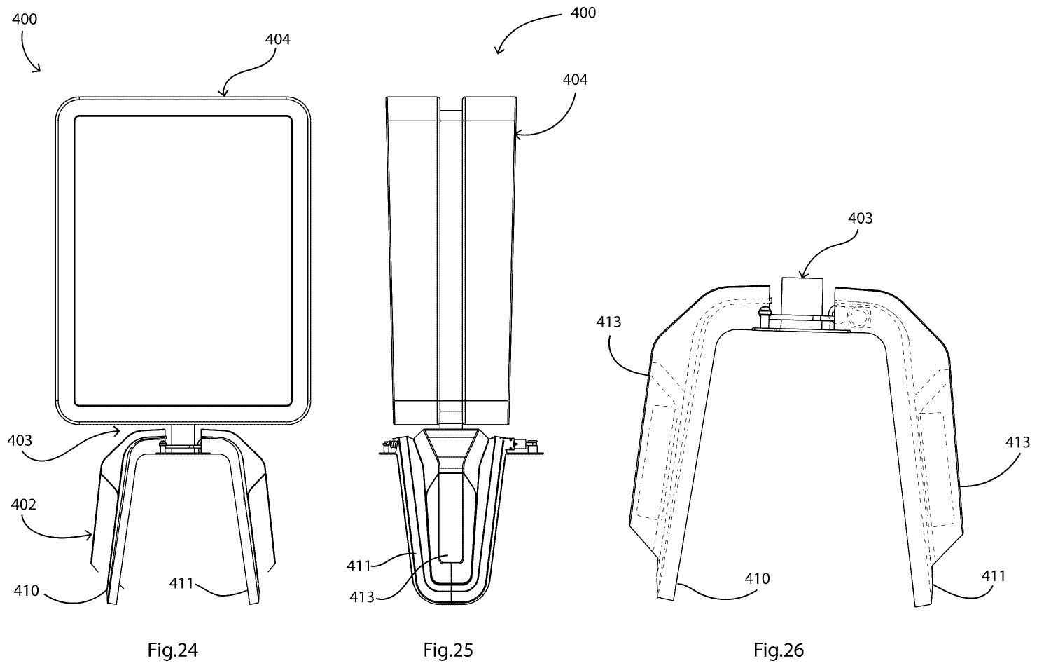

FIG. 24 is a front view of an alternative display sign of the invention,

FIG. 25 is a side view, and

FIG. 26 is an enlarged front view showing the sign's support structure in more detail,

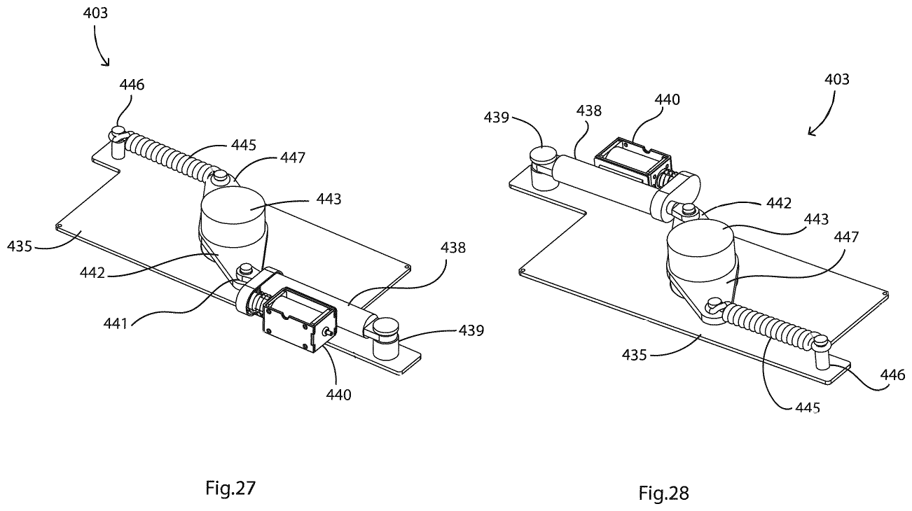

FIGS. 27 and 28 are top perspective view of the drive of the sign of FIGS. 24 to 26 from different angles,

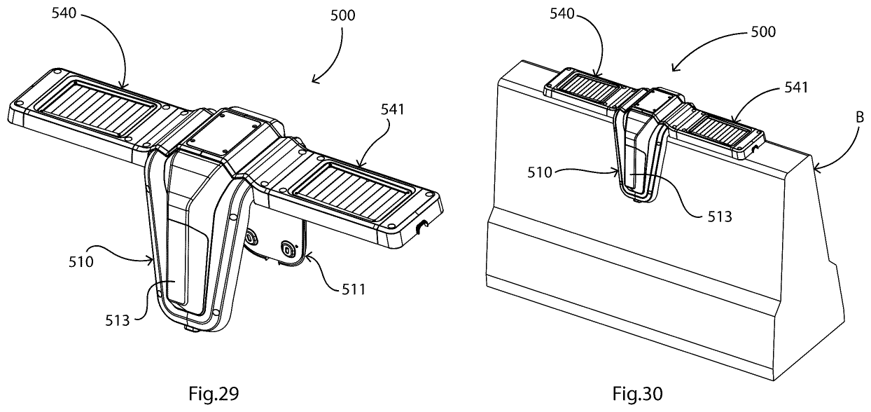

FIG. 29 is a perspective view of a support of a display sign of any embodiment, and

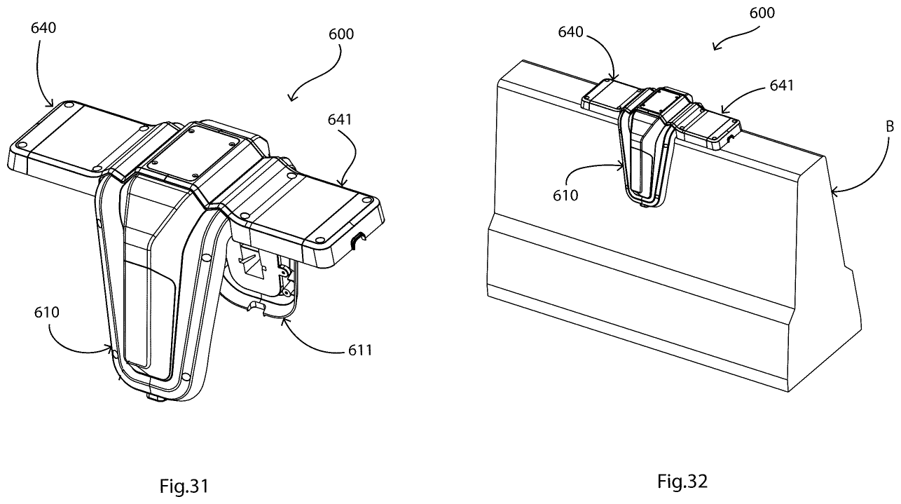

FIG. 30 is a perspective view of the support when mounted on a barrier,

FIG. 31 is a perspective view of a further support for use with any embodiment, and

FIG. 32 is a perspective view of the support when mounted on a barrier,

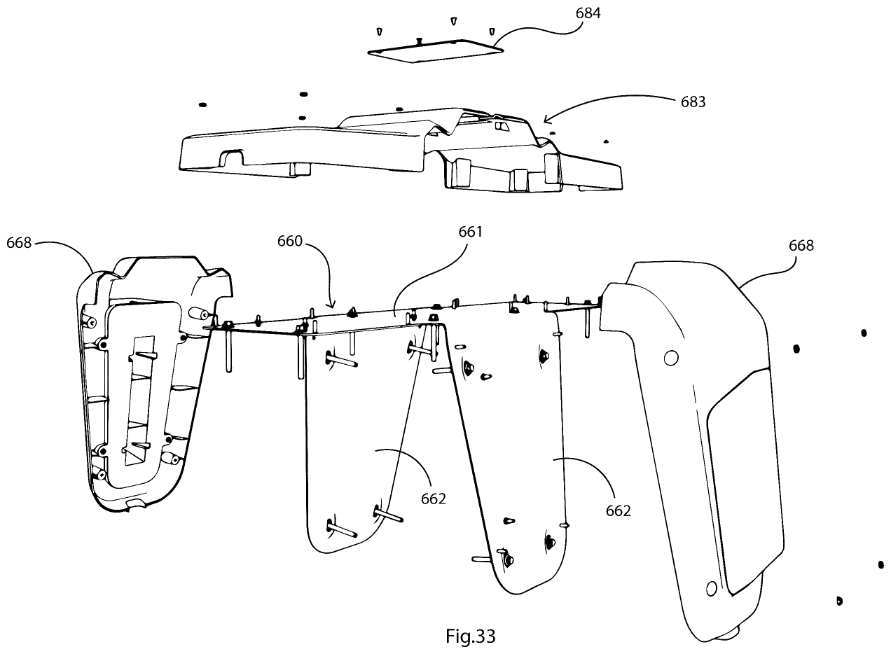

FIG. 33 is an exploded view of the support of FIGS. 31 and 32,

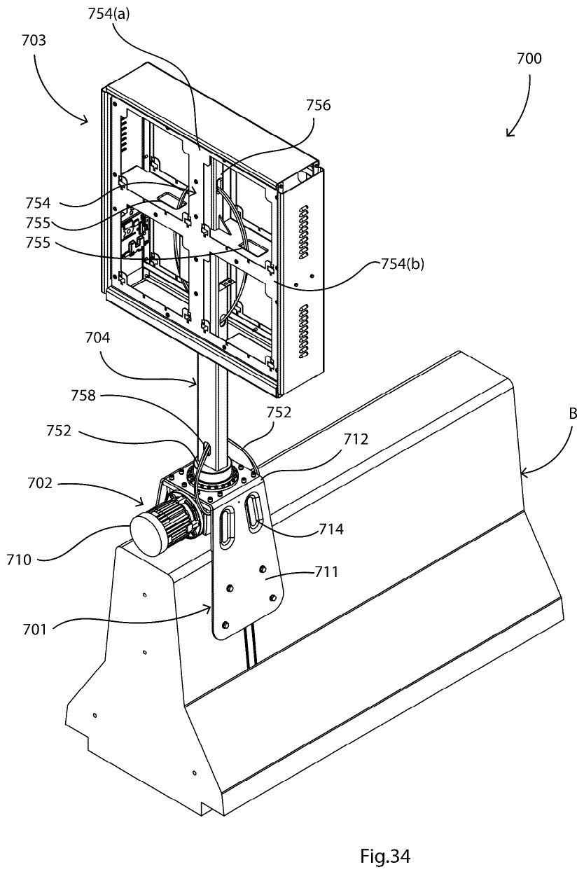

FIG. 34 is a perspective view of an alternative display sign of the invention when mounted to a concrete bollard, and

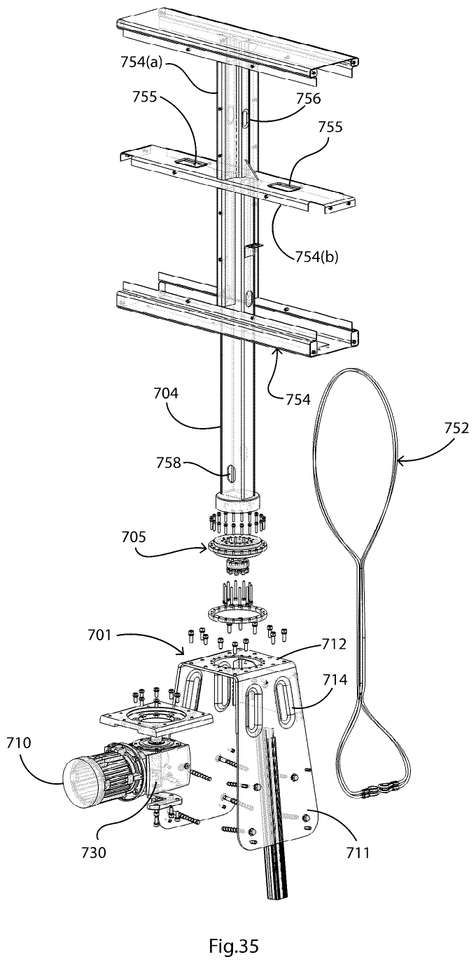

FIG. 35 is an exploded view showing mounting of the drive shaft to the base,

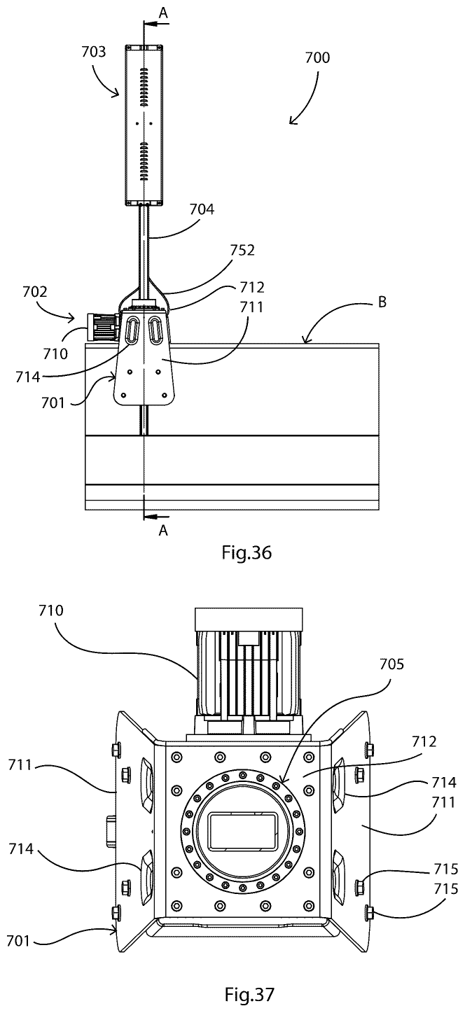

FIG. 36 is a side view of the sign, and

FIG. 37 is a plan view showing the base and motor,

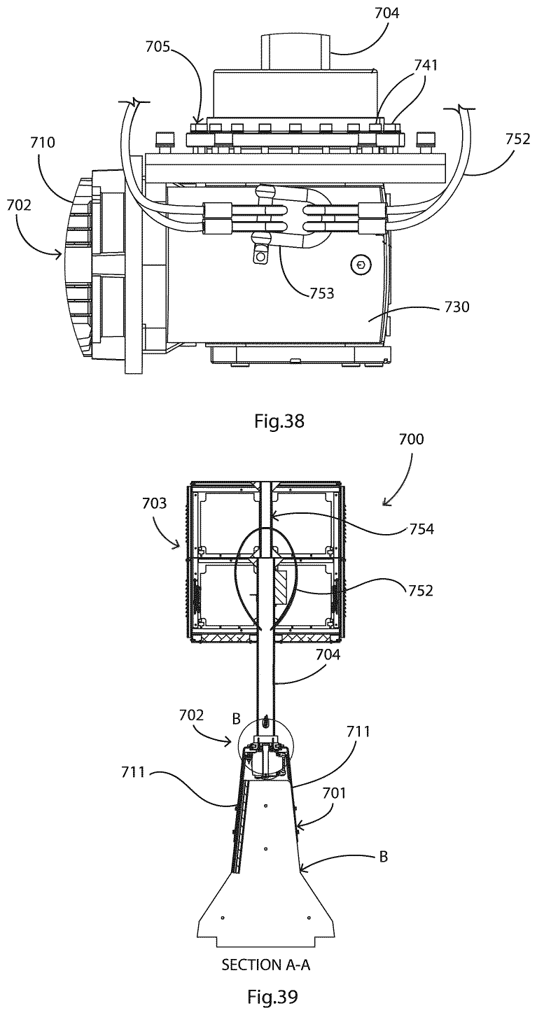

FIG. 38 is a vertical sectional view through the base showing the sign controller and shaft mounting arrangement,

FIG. 39 is an end view of the sign in position, and

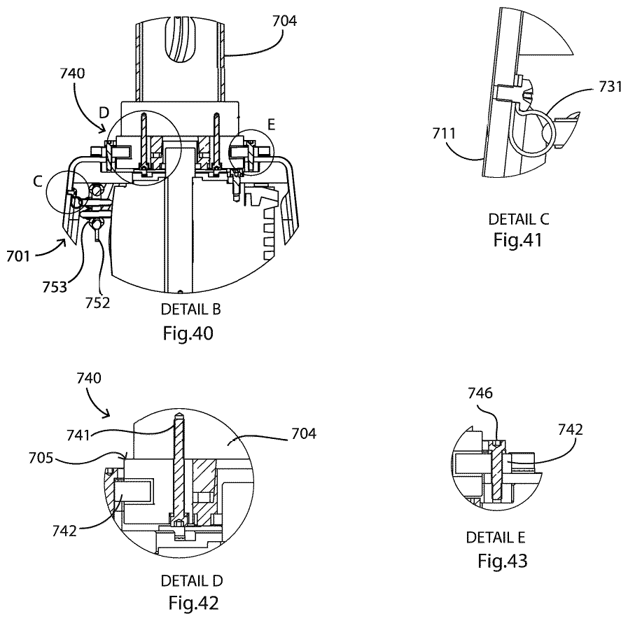

FIG. 40 is an enlarged view of Detail B of FIG. 39,

FIGS. 41, 42, and 43 are enlarged views of the Details C, D, and E respectively of FIG. 40, and

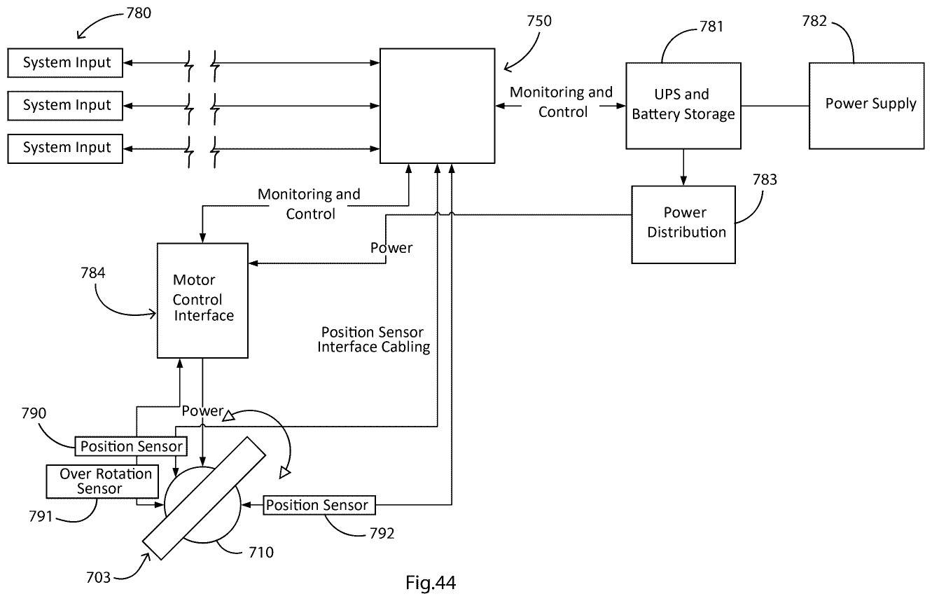

FIG. 44 is a block diagram illustrating the major functional components of the sign of FIGS. 34 to 43.

Referring to FIGS. 1 to 5 a roadside display sign 1, with a support or base 2 and a display 4, is for mounting on the central reservation barrier B of a dual carriageway or motorway. The signs of all examples described herein are linked by a communication network, wired or wireless, to a host system which provides control signals for display of relevant information to drivers on a real time basis. The sign 1 is robust, and is adapted to rotate, in this case up to 90°, for optimum visibility. Again, this rotation is under dynamic real time control. This invention is concerned primarily with the mechanical aspects of the sign, to provide the rotation, robustness and versatility in orientation.

The drive of the display signs of various examples provide that the display is aligned with a barrier (B) in use when not required but is turned to an optimal angle for visibility by drivers according to the driving conditions. The drive brings the display back to the default inoperative position when there is a power outage. The operative angle of orientation can be configurable to a set value suited to the curve of the road, or it may be determined in real time according to current weather and traffic conditions.

FIG. 1(a) shows the inoperative position of the sign in which the display is aligned with the barrier and so is unobtrusive. FIGS. 1(b) and 1(c) show the sign after movement through about 45° and about 90° respectively for optimum visibility by drivers in oncoming traffic according to the line of the road as it approaches the sign. As described below the drive mechanism includes a default mechanism to return the display to the inoperative position as shown in FIG. 1(a) in the absence of power. This optimises safety and maintenance of the sign. In other examples the angle may be different from 90°, for example up to 130°.

The sign 1 comprises a base 2 which is saddle-shaped for fitting to the top of a concrete barrier of the type mounted down the central reservation of a dual carriageway or motorway. However, the base 2 can fit to any wall-like structure. The base 2 has downwardly-depending legs 10 and 11 linked by a bridge 12 across the top, the bridge 12 being adapted to fit to the top of the barrier. LED strips 13 are mounted to the legs 10 and 11. A display support and drive apparatus 3 is mounted to the bridge 12, supporting a display 4 having two opposed display screens 20 and 21, as shown most clearly in FIG. 3. FIG. 4 shows that the drive apparatus 3 is mounted within and protrudes upwardly from the bridge 12, and it rotates a drive shaft 30 having a flange 31 connected to a flange 32 on a support pillar or shaft 33 for the screens 20 and 21.

As shown most clearly in FIGS. 4 and 5, the drive apparatus 3 comprises a housing 35 with a pair of opposed lower flanges 36 connected to the bridge 12. A motor 37 drives the output shaft 30 under control of signals which are received from the host system or another sign. A default mechanism is mounted to the shaft 30 to return the shaft 30 to a default angle in the absence of power. The default mechanism comprises a rack 40 engaging a gear 43 around the shaft 30, and a spring 42 mounted to pull the rack to slide in its elongate housing to cause the shaft 30 to rotate back to a default position.

The electric motor 37 is fixed into the metal housing 35 for protection and to add structural strength to the overall unit. The motor is directly connected to the centre shaft 30, which rotates through 90°. When the display 4 is in the operative position an electromagnetic clutch engages and holds the display 4 in position, and once switched off the display rotates back into the home position. As a fail-safe if the unit loses power, the electromagnetic clutch disengages, and the spring 42 pulls the display back to its home position.

Referring to FIGS. 6 to 13, an alternative sign 100 comprises a base 102 which is also saddle-shaped for fitting to the top of a concrete barrier. The base 102 has downwardly-depending legs 110 and 111 linked by a bridge 112 across the top, the bridge 112 being adapted to fit to the top of the barrier. The legs 110 and 111 support LED strips 113. A display support and drive apparatus 103 is mounted to the bridge 112, supporting a display 104 having two opposed display screens 120 and 121, as shown most clearly in FIG. 7. FIG. 8 shows that the drive apparatus 103 is mounted to and protrudes upwardly from the bridge 112, and it drives a drive shaft 120 having a flange 131 connected to a flange 132 on a support pillar 133 for the screens 120 and 121.

As shown most clearly in FIGS. 9 to 13, the drive apparatus 103 comprises a housing 135 with a pair of opposed lower flanges 136 connected to the bridge 112. A motor 137 drives the output shaft 130 under control of signals which are received from the host. A default mechanism 140 is mounted to the housing 135 within a lower chamber of it, to return the shaft 130 to the default angle in the absence of power. The default mechanism 140 comprises a rack elongate housing 141 supporting a rack 142, allowing it to slide within the housing 141 while engaged with a pinion 143 on the output shaft 130. A helical spring 144 is mounted between the housing 141 and the rack 142 to bias the rack to a default position. The motor 137 is mounted in an offset manner with its axis parallel to the axis of the output shaft 130. The motor 137 has, as shown most clearly in FIGS. 12 and 13, an output pulley 152 driving a belt 151 which in turn drives a pulley 153 on the pinion 143. Hence drive from the motor 137 is indirectly provided to the output shaft 130, and the pulley 153 which receives the motor drive is also under control of the default mechanism 140 in the event of there being no power.

In summary, the electric motor 137 is fixed to the metal housing 135 for protection and to add structural strength to the overall unit. The motor is connected via a gear or belt and pulleys to the display, with use of an applicable gear/pulley ratio to achieve more torque so that a smaller motor can be used to rotate the display 104 through up to 90°. When the display 104 is in the operating position an electromagnetic clutch engages and holds the display in position and once switched off the display 104 rotates back into the home position. As a fail-safe if the unit loses power, the electromagnetic clutch disengages, and the spring 144 spring pulls the display 104 back to its home position.

The drive apparatus 103 has the advantage of being compact in the vertical direction, with the motor being mounted alongside, offset from the longitudinal axis of the output display shaft 133. Hence, the display 104 is closer to the wall or barrier and less exposed to wind.

Referring to FIGS. 14 to 18 an alternative sign 200 comprises a base 202 which is saddle-shaped for fitting to the top of a concrete barrier of the type mounted down the centre of a dual carriageway or motorway. However, the base 202 can fit to any wall-like structure. The base 202 has downwardly-depending legs 210 and 211 linked by a bridge 212 across the top, the bridge 212 being adapted to fit to the top of the barrier. Each of the legs 210 and 211 has an elongate LED illuminator 213 to provide warning indications to motorists.

A display support and drive apparatus 203 is mounted to the bridge 212, supporting a display 204 having two opposed display screens 220 and 221, as shown most clearly in FIG. 15. FIG. 16 shows that the drive apparatus 203 is mounted within and protrudes upwardly by only a small amount from the bridge 212, and it drives a drive shaft 242 of the display 204.

The drive apparatus 203 comprises a base plate 235 having bearings, not shown, supporting the display shaft 242. A pneumatic ram actuator 237 has a cylinder 238 and a piston 239. The latter drives in a reciprocating manner a rack 240 sliding in a housing 241, and the rack 240 engages a ring gear 243 around the shaft 242. The actuator 237 extends the push rod (piston) 239 which is connected to the rack and gear to rotate the display 204 through 90°, the air pressure holding the push rod in its extended position. To rotate the display back home the air pressure is released under control of a control circuit, not shown, and a spring inside the ram actuator 237 pulls the piston 239 back into its home position. This spring is also a fail-safe if for any reason that the air pressure unexpectedly drops.

Referring to FIGS. 19 to 23 another alternative sign 300 comprises a base 302 which is saddle-shaped for fitting to the top of a concrete barrier of the type mounted down the centre of a dual carriageway or motorway. However, the base 302 can fit to any wall-like structure. The base 302 has downwardly depending legs 310 and 311 linked by a bridge 312 across the top, the bridge 312 being adapted to fit to the top of the barrier. Linear LED strips 313 are mounted to the legs 310 and 312.

A display support and drive apparatus 303 is mounted to the bridge 312, supporting a display 304 having two opposed display screens 320 and 321, as shown most clearly in FIG. 20. FIG. 21 shows that the drive apparatus 303 is mounted within and protrudes upwardly by only a very small extent from the bridge 312. As shown in FIGS. 22 and 23, a display drive shaft 360 is mounted by bearings, not shown, to a base plate 335. An electronic actuator 337 drives a piston 339 to move a rack 340 having rack teeth 341 engaged with gear teeth 342 around the display shaft 360.

In this case a default return mechanism comprises a rack 350 sliding in an elongate housing 351 and biased by a helical spring 352 to a default position in absence of power to the actuator 337. The linear actuator 338 extends the piston 339 which is connected to the rack 341 and gear 342 to rotate the display 304 through 90°. The actuator 337 holds the push rod in its extended position. To rotate the display back home the linear actuator 337 pulls the push rod back into its home position. As a fail-safe if the unit loses power, the spring pulls 352 pulls the display back to its home position.

Referring to FIGS. 24 to 28 a further alternative sign 400 comprises a base 402 which is saddle-shaped for fitting to the top of a concrete barrier of the type mounted down the centre of a dual carriageway or motorway. However, the base 402 can fit to any wall-like structure. The base 402 has downwardly-depending legs 410 and 411 linked by a bridge across the top and supporting linear LED strips 413. The bridge is adapted to fit to the top of the barrier. A display support and drive apparatus 403 is mounted to the bridge, supporting a display 404 having two opposed display screens 404, as shown most clearly in FIG. 25. FIG. 26 shows that the drive apparatus 403 is mounted within and protrudes by only several cm upwardly from the bridge, and it drives a drive shaft 443 (FIG. 27) to turn the display 404.

As shown particularly in FIGS. 27 and 28 the drive apparatus 403 has a base plate 435 which is adapted to be secured to the bridge, and it supports via bearings the display shaft 443. A solenoid 440 drives a rod 441 in a cylinder 438 from an anchor pin 439. The rod 441 is linked with a swing arm 442 in a crankshaft-like arrangement to rotate the shaft 443. Again, this drive mechanism has a very low profile and so fits within the bridge in a manner which minimises the distance between the display screens and the bridge. It is preferred to minimise this distance to minimise the effect of wind and air turbulence from passing traffic. Default return in absence of electrical power is provided by a helical spring 445 extending from an arm 447 to a fixed pin 446 on the base plate 435.

The swing arm 442 supports two tubes and a solenoid 440 is attached to the outer tube. ‘Once the electric solenoid 440 is activated it pushes the inner tube forward which turns the swing arm 442 and rotates the display 404 through up to 90°. The expansion spring 445 also has a fixed position and once the swing arm 442 has moved the spring 445 will expand and stay under consistent pressure until the solenoid 440 is switched off and the main link arm 442 returns to the home position. This is a safety detail which allows the display sit in the home position even if the solenoid or link arm fails.

It will be appreciated that the invention provides for display of a wide range of applicable information to assist driver safety. The sign can be mounted to the barrier in a manner which achieves excellent structural integrity, with the base enveloping around the side and top surfaces of the barrier. Where a piston is used, either solenoid, linear actuator, or pneumatic there is a benefit of a particularly low profile, allowing the display screens to be very close to the saddle. This distance can be as short as 1 cm.

Referring to FIGS. 29 and 30 a sign of any embodiment described above may include a base or support 500 which extends longitudinally in both directions on the top surface of the barrier B. The support 500 has downwardly depending on legs 510 and 511 arranged to be secured to opposed later surfaces of the barrier B. Each leg 510 and 511 supports an LED strip 513 for conveying warnings to drivers. Also, the support 500 has longitudinal extensions or “wings” 540 and 541 extending longitudinally and secured to the top of the barrier. Moreover, the projections 540 and 541 support solar panels to provide a degree of independence of power supply for the sign.

The support 500 provides the advantage that there is very secure anchoring of the support in all four orthogonal directions and also vertically by virtue of the legs 510 and 511.

Referring to FIGS. 31 to 33 another support, 600 has these attributes, although in this case solar panels are not attached. There are legs 610 and 611 and wings 640 and 641 providing anchoring on the barrier B in all four orthogonal directions. Referring specifically to FIG. 33 the support 600 has a metal substrate 660 with a top platform 661 and leg substrates 662 as an integral structure. The substrate 660 is secured by bolting to the barrier and so there is very strong anchoring. The other components are attached in a modular manner which allows ease of maintenance by part replacement. These components include a top housing 683 with a top plate 684 for housing an electronic controller and wireless interface, and an LED cover 668 which fits in a modular manner to the relevant leg substrate 662.

### Advantages of the Support 600:

The baseplate 660 enables ease of installation-once-off structural fixing to the barrier
The baseplate 660 enables safer installation of the remaining parts as it can be fitted in one operation in advance of modular elements. Modular elements can then be fitted quicky
This arrangement enables safer maintenance and repair as it removes the need to detach and re-attach units to the baseplate by avoiding slow drilling process as the baseplate is a once off fitting that the modular element attach to. If maintenance or replacement of the modular elements is required, it is a faster process as no drilling is required. This reduces the time under a temporary traffic management closure and time spent by operatives in a high-speed environment.
The modular construction enables only a failed or damaged module to be replaced without changing the entire unit thereby reducing costs and waste.
The modular construction enables the rest of the unit to operate if one part is not working or damaged.
The modular aspect enables more wings and solar panels to be fitted to suit a location depending on the solar aspect available
The configuration, shape and profiling of the base, the legs and wings enables rainwater to flow over the LED lens and the solar panels to provide a degree of self-cleansing.
The modular configuration and flexible electronic and software design enables the deployment of single-or double-sided LED arrays and the choice of LED pattern.
The modular construction provides a number of options relating to how the systems components are power offering options including fixed wiring and solar power the available space also offers options to accommodate a range of battery sizes.

### Additional Alternative Display Signs

It is envisaged that a sign of the invention may have a support for mounting to something other than a barrier or wall-like structure. For example, it may be pole-mounted. In the latter case, the sign may not have a base which is saddle-shaped, and it may have a conventional fixture for fixing to the pole. Such a sign would have the advantages of the rotation drive as described herein for any embodiment. In a further alternative, the sign may be adapted for mounting on a pole or a fixture on a pole and have two side substrates for attaching to sides of the pole or fixture. This would provide the benefits of strong anchoring on the support and LED display on both lateral sides.

Referring to FIGS. 34 to 43 an alternative sign of the invention is now described, and FIG. 44 shows the major functional components.

The sign is indicated by the numeral 700. It has a base 701 configured with a saddle shape to engage a barrier B. A drive for the sign is indicated generally by the numeral 702 and in this case, it resides within the base 701 in use above the barrier B, being between lateral wings 711 and beneath a bridge or top plate 712 of the base 701. The wings 711 have dimples 714 at the upper ends which are positioned above the level of the barrier B in use, providing additional strength to the base. The wings are secured by bolts 715 to the barrier B.

A motor 710 protrudes longitudinally on one side, being part of the drive 702 secured to the bridge plate 712. There is a display 703 with display elements for providing information for drivers, and this is mounted to a vertical shaft 704 of rectangular cross-sectional shape extending from the drive 702 via a slewing plate 705.

As shown most clearly in FIGS. 35, 38 and 40 there is a cleat 753 secured to a wing 711 and through which a tethering cable 752 is trained. The cable 752 is also trained up through the drive shaft 704 and is trained in a loop around a frame 754 of the display 703. This ensures that in the unlikely event of an impact on the display 703 it will not become dislodged, being instead retained by the tethering cable 752 to the base 701.

FIG. 35 also shows how the motor 710 is secured to a housing 730 with a bevel gear mechanism. This housing also houses some control electronics including a motor drive interface 784. As described in more detail below there is a processor and this may be external and linked to the motor drive interface 784, or it may be housed within the housing 730.

The tether 752 is trained through the cleat 753 which is retained securely beneath the bridge plate 712. The tether 752 forms a loop by extending through apertures 758 in the lower end of the shaft 704, and it extends through apertures within the shaft 704 and the frame 754 of the display 703. Advantageously, the frame 754 has a vertical member 754(a) of rectangular cross section and which is an extension of the shaft 704. The vertical member 754(a) extends through cross beams 754(b). The central cross beam has apertures 755 and the vertical member has an aperture 756 for the tether 752. Hence the tether 752 is looped through both horizontal and vertical structural members of the display 703 and back around the base top plate 712 and between the wings 711. This provides a very strong anchoring of the tether in the event of the display 703 being struck by a vehicle, helping to prevent the display breaking off and being a hazard on the road.

It is very advantageous that the vertical drive shaft 704 is of rectangular shape, as that provides for excellent torque application to the frame 754 without slippage, irrespective of wind conditions. It is more advantageous that the vertical display frame member is integral with the shaft 704.

FIG. 41 particularly shows an eyelet 731 for the tethering cable 752 to ensure that it is trained correctly and does not protrude excessively from the bridge 712.

FIGS. 42 and 43 shows a mounting assembly 740 for the slewing plate 705, being engaged to the motor gear output by torque bolts 741. This diagram also shows an annular ring 742 which is received in a corresponding radial groove of the slewing plate 705 to hold it in position and allow it to rotate. The ring 742 is supported by bolts 746.

The functional components of a system incorporating the sign 700 are shown in FIG. 44. Input devices 780 provide configuration settings to a processor 750, and also to provide real time traffic and weather data. For example, a device 780 may be a radar device. The inputs which are provided from the devices 780 are used by the processor to rotate the display 703 to an optimum orientation to suit the real time conditions. The processor 750 is linked to a UPS and battery storage 781, in turn linked to a mains power supply 782.

The battery 781 is linked with a power distribution circuit 783 which is linked to a motor control interface 784, which also receives control signals from the processor 750. The interface 784 provides power to the motor 710 to rotate the sign via the coupler according to control signals from the processor 750 and also according to a first position sensor 790, an over-rotation sensor 791 a second position sensor 792. These sensors are built into the housing 730, being rotary encoders of known type. The benefit of the three position sensors is that they provide comprehensive feedback to the controller 750, indicating the desired start and end angular positions of the slewing plate 705 and also if there has been over-rotation as determined by the sensor 791. The sensors may be rotary encoders of any known type to detect rotation of the drive shaft or a coupler secured to it. The sensors may additionally or alternatively be embedded within the motor.

### Example Control Flow

The sensors 790-792 are monitored by the processor 750. Based on the system inputs 780 the processor 750 determines there is an incident and the sign 703 needs to be deployed to alert drivers. The default home position is parallel to the base wings 711, so that it is as unobtrusive as possible, aligned with the barrier B in use. The use position is at an angle to this so that it is optimally viewed by drivers. This angle is configurable, depending on the curve of the road where it is to be placed.

The processor 750 provides a signal to the motor control interface 784 to apply power to the rotatable sign 703. The processor 750 monitors the rotation of the sign based on feedback from the position sensors 790-792 and the duration of power applied to the sign, and it continuously monitors the system power supply and the state of the UPS and battery storage 781. In the event of loss of incoming power the processor 750 will continue to monitor the state of the UPS and battery storage 781. If the loss of power persists and the incident is ongoing the processor 750 will provide a signal to the motor control interface 784 to return the sign to its home position when the battery storage has less than 5 minutes (configurable) remaining.

The operative angle of orientation can be configurable in the processor 750 to a set value suited to the curve of the road, or it may be determined in real time according to current weather and traffic conditions received via the inputs 780.

Hence in this case there is no need to for a mechanical return spring. However, it is envisaged that a sign of the invention may have both a mechanical return and also the above functional components to ensure that the display is at a correct desired home orientation in the event of a power failure.

Components of embodiments can be employed in other embodiments in a manner as would be understood by a person of ordinary skill in the art. The invention is not limited to the embodiments described but may be varied in construction and detail.

1. A roadside display sign comprising:
a base configured to engage a barrier, wall or fence,
a display with display elements for providing information for drivers, and
a display drive apparatus comprising a motor and being mounted to the base and being adapted to rotate the display,
wherein the drive apparatus is adapted to rotate the display about a vertical axis extending from the base.

2. (canceled)

3. The display sign as claimed in claim 1, wherein the base comprises a pair of opposed legs joined by a bridge to form a saddle shape to encompass the top of a wall or barrier, and the drive apparatus is mounted to the bridge.

4. The display sign as claimed in claim 1, wherein the drive apparatus is mounted substantially centrally on the bridge, in a manner which is symmetrical with respect to the legs.

5. The display sign as claimed in claim 1, wherein the drive apparatus comprises an output shaft which is linked to a shaft of the display; and wherein the drive apparatus has an output shaft which is joined by flanges to the display shaft.

6. (canceled)

7. The display sign as claimed in claim 1, wherein the drive apparatus comprises a default mechanism to rotate the display to a default home orientation in absence of electrical or other power provided to the drive apparatus.

8. The display sign as claimed in claim 1, wherein the drive apparatus comprises a default mechanism to rotate the display to a default home orientation in absence of electrical or other power provided to the drive apparatus; and wherein the base comprises a pair of opposed legs joined by a bridge to form a saddle shape to encompass the top of a wall or barrier, and the default home position is parallel to the legs whereby the display does not protrude to a greater lateral extend than the base.

9. The display sign as claimed in claim 1, wherein the drive apparatus comprises a default mechanism to rotate the display to a default home orientation in absence of electrical or other power provided to the drive apparatus; and wherein the default mechanism comprises a spring providing a bias to the home orientation.

10. (canceled)

11. The display sign as claimed in claim 1, wherein the drive apparatus comprises a default mechanism to rotate the display to a default home orientation in absence of electrical or other power provided to the drive apparatus; and wherein the default mechanism comprises a rack engaging a gear on or linked to the display shaft, the rack being biased to slide to cause rotation of the gear to the home position.

12. The display sign as claimed in claim 1, wherein the drive apparatus comprises a default mechanism to rotate the display to a default home orientation in absence of electrical or other power provided to the drive apparatus; and wherein the default mechanism comprises a biased rod which is actuated in a linear path to cause rotation of the display shaft to a home position; and wherein the rod is linked to a rack to move longitudinally to rotate a gear or to rotate a crank arm to cause rotation of the display shaft.

13. (canceled)

14. (canceled)

15. The display sign as claimed in claim 1, wherein the motor is mounted alongside and offset from a longitudinal axis of the display shaft, and a lateral power transfer means is provided to link a motor output to the display shaft.

16. The display sign as claimed in claim 1, wherein the base comprises a pair of opposed legs joined by a bridge to form a saddle shape to encompass the top of a wall or barrier, and the drive apparatus is mounted to the bridge; and wherein the base comprises a substrate having a saddle shape with a top plate and lateral legs extending downwardly and laterally on each lateral side and the substrate being arranged to be fastened at the top plate and the legs to a barrier; wherein the substrate is integral, and is of metal material.

17. (canceled)

18. The display sign as claimed in claim 1, wherein the base comprises a substrate having a saddle shape with a top plate and lateral legs extending downwardly and laterally on each lateral side and the substrate being arranged to be fastened at the top plate and the legs to a barrier; and wherein the base comprises, on one or both legs, a removable cover for mounting over an array of light sources.

19. The display sign as claimed in claim 1, wherein the base comprises a substrate having a saddle shape with a top plate and lateral legs extending downwardly and laterally on each lateral side and the substrate being arranged to be fastened at the top plate and the legs to a barrier; and wherein the substrate top plate supports a circuit and extends longitudinally in opposed directions beyond a central location supporting the circuit.

20. The display sign as claimed in claim 1, wherein the sign comprises a controller and sensors to detect angle of rotation of the display and to control rotation accordingly.

21. The display sign as claimed in claim 1, wherein the drive apparatus comprises a default mechanism to rotate the display to a default home orientation in absence of electrical or other power provided to the drive apparatus; and wherein the sign comprises a battery storage device and a controller configured to monitor available power independently available to the sign and to pre-emptively cause the sign to rotate to the home default position in advance of power reducing excessively.

22. The display sign as claimed in claim 1, wherein the sign further comprises at least one tethering cable linked to the base and the display, the cable having a strength to retain the display in the event of an impact on the display.

23. The display sign as claimed in claim 1, wherein the sign further comprises at least one tethering cable linked to the base and the display, the cable having a strength to retain the display in the event of an impact on the display; and wherein the cable is looped, being trained through the shaft and around a frame of the display and back to the base.

24. The display sign as claimed in claim 1, wherein the sign further comprises at least one tethering cable linked to the base and the display, the cable having a strength to retain the display in the event of an impact on the display; and wherein the display comprises a frame with a vertical member aligned with the shaft and a cross member, and the tether is trained through said vertical and cross members; and wherein the vertical member is a continuation of the drive shaft and said drive shaft has a rectangular cross-sectional shape.

25. (canceled)

26. The display sign as claimed in claim 1, wherein the drive apparatus is adapted to rotate the display to an angle of orientation chosen in real time according to conditions as indicated in data received from an interface.

27. The display sign as claimed in claim 1, wherein the drive apparatus is adapted to rotate the display to an angle of orientation chosen in real time according to conditions as indicated in data received from an interface; and wherein the conditions include current weather and/or current traffic.
